(19) United States
(12) Patent Application Publication
(10) Pub. No.: US 2024/0079734 A1
(43) Pub. Date: Mar. 7, 2024

(54) Cell connectors for battery

(71) Applicant: Damon Motors Inc., Vancouver (CA)

(72) Inventor: Brian Ford, Petaluma, CA (US)

(21) Appl. No.: 17/902,144

(22) Filed: Sep. 2, 2022

(51) Int. Cl. H01M 50/533; H01M 10/04

(52) U.S. Cl. CPC H01M 50/533; H01M 10/0404

(57) ABSTRACT

Traditional battery assembly involves welding the vulnerable crimp electrodes after positioning the cells in the pack, which may lead to wastage of the entire pack if a single weld fails. To overcome this, electrode connectors are pre-welded to the crimp terminals of the cells and the welds tested before the cells are assembled in the battery. Electrode connectors for the other cell terminals are pre-assembled in the collector stack. The electrode connectors are generally circular and can be welded in any rotational orientation. The connectors have an upper annulus below which extend legs and a foot or feet. The annuli are welded to the collectors in the stack and the foot or feet to the cells. Compression of the electrode connectors compensates for dimensional differences in the cells. Holes through the collector stack allow for hot gases to escape in the event of a cell failure.

### TECHNICAL FIELD

This invention relates to holding and connecting electrical cells in a battery. More specifically, it relates to the cell connections to a layered assembly of collectors.

### BACKGROUND

Advances in technology and an increasing desire to reduce damage to the environment have led to the more widespread adoption of electric vehicles. The development of safer and more efficient electro-chemical cells and cell production is important for the economic expansion of these fields since assembling and mechanically retaining battery cells in a battery pack can be difficult.

One such evolution is the accessibility of both terminals on the top of the cell instead of at either end. However, this type of configuration, while beneficial, creates additional challenges. The proximity of the opposing polarity terminals on such a small surface runs the risk of creating a short circuit. Loose cells in the packs may cause an electrical danger or fire, either during manufacturing, in use or in service. This is also a hazard in the case when a battery pack is physically damaged, for instance as a result of a crash.

Traditionally, making the physical connections to the top of a cell may lead to loose and lost connections or accidental cell penetration. Failure to correctly assemble even a singular cell may result in rejecting an entire module (group of cells in a battery pack) at the end of a relatively long production process.

This background is not intended, nor should be construed, to constitute prior art against the present invention.

### SUMMARY OF INVENTION

The present invention relates to a system and method for electrically connecting cells in a cell holder, and the resultant battery pack. The battery pack has elements in the cell and current collector interconnection which facilitate the welding of cells. These elements are formed rings that allow the most difficult part of the cell welding process, and the welds that are most likely to fail, to be removed from the assembly of the current collector to the module. It allows them to be welded in a much more controlled, preliminary process, which permits welds to cells to be evaluated individually prior to the cells being populated into their modules. This is different from the conventional sequence of fully populating cells in a battery pack frame and subsequently performing all the welding. If one cell is bad in a module in the conventional method, the whole module is likely to be scrapped, as reworking these welds is next to impossible once the current collector is attached to the module.

Embodiments of the invention enable more robust terminal connections because pre-welding is implemented, leading to a more accurate battery assembly process, which consequently becomes simplified and faster. For example, the negative, anode ring is pre-welded to the cell surface, and the positive, cathode ring is pre-welded to the collector stack, before any further assembly. Historically, the anode crimp weld, to the cell's small, thin, curved edge has been a challenging weld inside the battery module, with an inherent risk of over-penetration as the cross-section changes through the weld. The anode ring tabs or feet are radiused to conform to the battery crimp area so that there are no or minimal gaps, and the anode foot radius is slightly smaller than the radius on the cell crimp so that when a compressive force is applied it conforms. The anode pre-weld to the cell crimp forms the bottom-up anode connection weld, beginning from the cell. The cathode pre-weld to the positive collector plate is a top-down cathode connection weld starting from the collector stack.

The anode ring features increase the terminal contact surfaces with tri-lobe triple redundancy weld locations, for example. These provide additional current paths to the current collectors from the cells and act to keep the cell seals intact by reducing heating, since there are additional conductor cross-sections. The duration of the welds to the top of the anode and cathode rings may be longer than to the cells because they are a physically larger weld and create more bond area. The anode ring has spring compliance so that it has reliable, repeatable, intimate contact with the underside of the conductor layer for its subsequent connecting weld. The cathode ring also has a spring compliance effect so that it has reliable, repeatable, intimate contact with the top of the cell button for its subsequent connecting weld. Compression compliance of the anode and cathode rings allows for more reliable, repeatable interconnects from the cell to the current collectors that accommodate manufacturing size variations of cells and compensate for dimensional differences in cell heights. As a result of the features of the electrode rings, the likelihood of cell rejection or failure is thus reduced. Additionally the compliance in the rings allows for less complicated and less costly weld fixturing and tooling.

Disclosed is a set of electrode connectors for a cell comprising: a first electrode connector comprising a first annulus, multiple first legs extending from the first annulus, and a first foot extending from each first leg, wherein the first feet fit over a crimp of the cell; and a second electrode connector comprising a second annulus, multiple second legs extending from the second annulus, and a second foot at which the second legs terminate, the second foot dimensioned to fit inside the first annulus.

Also disclosed is a battery comprising multiple cells and for each cell: a first electrode connector comprising a first annulus, a plurality of first legs extending from the first annulus, and a first foot extending from each first leg, wherein the first feet are connected to a crimp of the cell; and a second electrode connector comprising a second annulus, a plurality of second legs extending from the second annulus, and a second foot at which the second legs terminate, the second foot connected to a button terminal of the cell.

Further disclosed is a method for assembling a battery of multiple cells, the method comprising: connecting a first electrode connector to each cell by connecting multiple first feet of each first electrode connector to a crimp of each cell, each first electrode connector comprising a first annulus and a plurality of first legs extending from the first annulus and terminating in one of the first feet; connecting, for each cell, a second electrode connector to a collector stack, each second electrode connector comprising a second annulus, a plurality of second legs extending from the second annulus and a second foot at which the second legs terminate; connecting the collector stack with the connected second electrode connectors to the first annuli; and connecting each second electrode connector connected to the collector stack to a button terminal of each cell.

### BRIEF DESCRIPTION OF DRAWINGS

The following drawings illustrate embodiments of the invention, which should not be construed as restricting the scope of the invention in any way.

FIG. 1 is a perspective view of a battery cell with an anode ring, according to an embodiment of the present invention.

FIG. 2 is a perspective view of a battery cell displaying a cathode ring with intervening components removed, according to an embodiment of the present invention.

FIG. 3 is a perspective view of a battery cell displaying both rings with intervening components removed, according to an embodiment of the present invention.

FIG. 4 is a cross-sectional view of an assembled collector stack and cell top, according to an embodiment of the present invention.

FIG. 5 is a schematic drawing representing a cross-sectional view of a radial slice through a collector stack at a cell location, according to an embodiment of the present invention.

FIG. 6 is an exploded, perspective view of a collector stack with cathode rings, according to an embodiment of the present invention.

FIG. 7 is a drawing representing an assembled collector stack and cathode rings seen from above, according to an embodiment of the present invention.

FIG. 8 is an exploded plan view of a collector stack, according to an embodiment of the present invention.

FIG. 9 is a flowchart describing the steps in the assembly process of a battery pack according to an embodiment of the present invention.

### DESCRIPTION

### A. Glossary

Annealing—a heating and cooling treatment in metallurgy that alters the physical and chemical properties of the material to increase its ductility and reduce its hardness to make it more workable.
Anode—the electrode of a battery (electrical device) that releases electrons to the external circuit during discharge. The negative (−) electrode.
Annulus—this term is used to describe the upper (as shown in the figures), planar portion of an electrode connector that is circular, generally circular or forms a loop. The annulus defines a hole, an aperture, multiple holes, multiple apertures or a perforated dimple or recess.
Battery—a container or pack with one or more cells in which chemical energy is converted into electricity and used as a source of power.
Cathode—the electrode of a battery that absorbs electrons from the circuit. The positive (+) electrode.
Cell or electrical cell—this refers to a device capable of generating electricity from a chemical reaction. A cell typically has one positive terminal and one negative terminal. Cells may be rechargeable.
Collector—a form of metallic strip, spider, plate or other structure, usually but not necessarily a single piece of metal, that connects to terminals of one or more cells and is used as an electrical conductor for multiple components.
Conductor—a material, such as metal, which allows a flow of electrons (an electrical charge) to travel through it.
Electrode connector—an anode ring or a cathode ring.
Insulator—a material, such as rubber, which inhibits the free flow of electrons travelling through it.

Ring—this term is used to describe an electrode connector for a cell, the electrode connector being generally circular in shape.

### B. Exemplary Embodiments

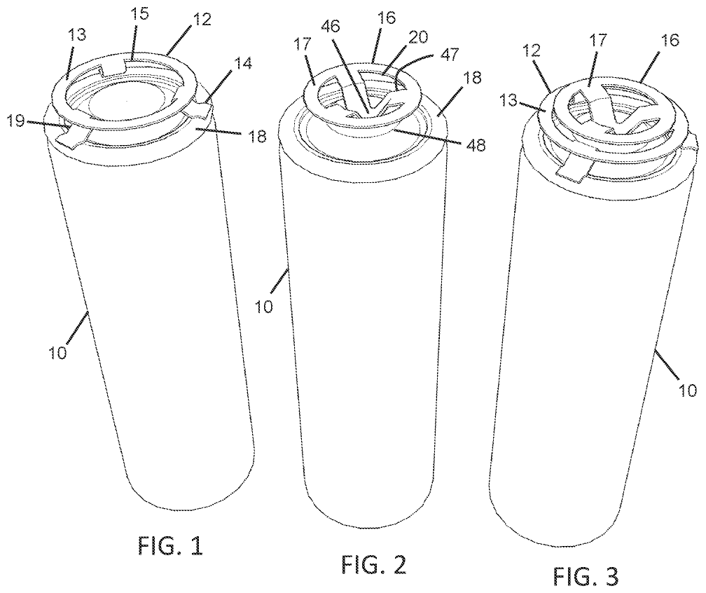

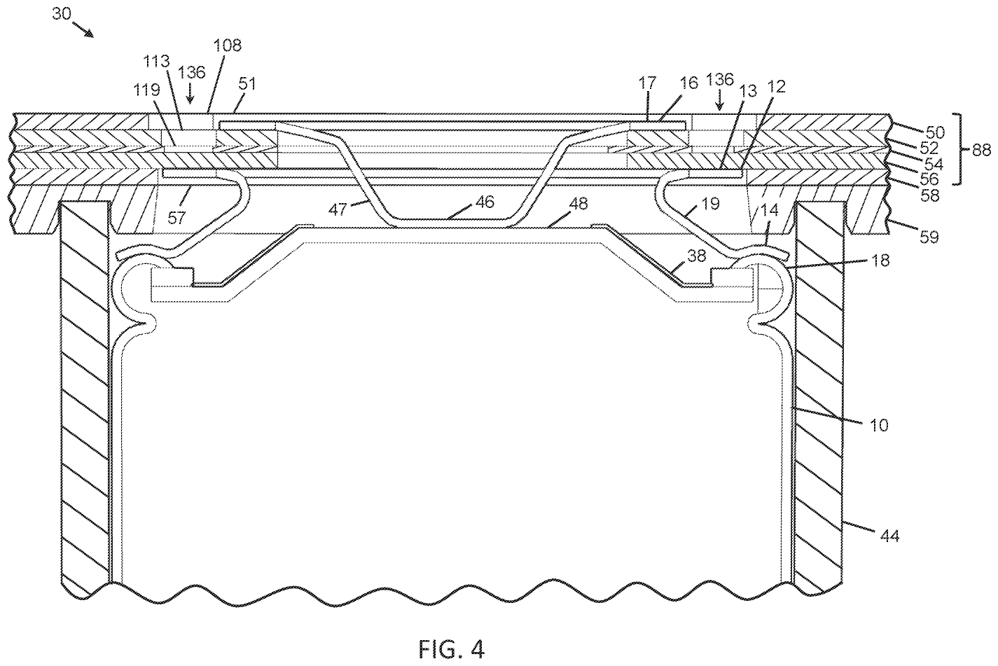

Referring to FIG. 1, there is shown a cell 10 and a negative, anode ring 12 in the anode ring-to-cell pre-weld assembly. The anode ring 12 is an example of an electrode connector. The anode ring 12 is pre-welded to the cell 10 by laser welding three anode feet 14 at equidistant points around the ring circumference to corresponding points on the cell crimp 18 at the top of the cell. The ring 12 is supported above the top of the cell 10 by three downwardly extended legs 19 which connect to corresponding feet 14. The feet are the only contact of the anode ring with the cell 10 and are found beyond the diameter of the annulus 13 because the ring legs also extend diagonally outward beyond the annulus diameter as they extend downward. The upper annulus 13 of the anode ring 12 is flat, and contact can be made with the negative collector 56 (FIG. 4) anywhere on the uppermost surface of the annulus during further stages of the assembly. Welding the anode ring 12 to the cell 10 is one of the first steps in the cell holder or battery pack assembly process. The anode feet 14 are additionally radiused to be slightly smaller in radius than the radius on the cell crimp 18 so that when a downward compression force is applied to the anode ring onto the cell, the feet conform to the profile of the crimp. The anode ring pre-weld to the cell crimp 18 forms the bottom-up anode connection weld, beginning from the cell.

The anode ring connection is chosen as the cell pre-weld before cell assembly in the frame 44 (FIG. 4) because the difficulty of alternately making all the crimp welds afterwards, while marrying the negative collector to the battery pack after loading with cells, make them the least-preferred welds. Prioritizing the anode ring crimp weld on the singular cell 10 as a first or early step during assembly increases successful secure connections in the assembled battery, and allows manufacturers to test these most difficult welds prior to committing the cells to the module.

The anode ring 12 is stamped out (cut) in a horizontally flat ring-like shape with internal projections. The projections are then formed into the legs and feet. The anode ring 12 is made of 110 copper, for example, for efficient conductivity. Also, 110 copper provides suitable springiness in the anode ring 12 when properly annealed.

For a number of reasons, the anode ring 12 is intentionally designed with a cutout 15. The main advantage of the multitude of air spaces built into the anode ring, as opposed to it being a full disc, and how it is supported above and beyond the cell 10 by its three extended legs 19 joined to three corresponding feet 14, is to provide routes for gas egress in the event of a cell failure.

The anode ring shape allows for 360 degrees of connections originating from any of the points on the top of the annulus 13 to a collector and from the bottom via legs to anywhere around the crimp of the cell. Three legs and welding points, for example, around the anode ring 12 effectively bind the ring to the cell 10 with sufficient mechanical strength. Also, for example, three welding points from the annulus 13 to the collector 56 effectively bind the ring to the collector with sufficient mechanical strength.

Triple redundant welds in either direction, to the cell 10 below and to the collector stack above, not only provide confidence in the long-term strength of the physical bond, but as well act as back-ups in case of an undetected weld failure. Three connections also create more conduction cross-section through the welds compared to a single connection, thereby reducing electrical resistance, resulting in heat reduction in the electrical system. For the upper connection, the triple welds act as an additional thermal bridge of the anode ring 12 to the thermal mass of the negative current collector 56 (FIG. 4). For the three anode foot welds to the crimp 18, this is again a reduction in the resistance, resulting in better heat dissipation in the overall system compared to a single weld. In the vulnerable thin crimp location, less heating helps avert crimp seal leakage.

A feature that is important is that the tri-lobe nature of the rings participates not only in the thermal bridge aspect but adds to the cross-section of the positive and negative conductor plates so that there is more path for electrons to flow from all adjacent cells. It is not just the current from each cell coming through its associated ring, but the current of adjacent cells using this extra material to pass more efficiently across the conductor. These are subtly different benefits that add to the overall efficiency of the collector and ring system.

The symmetry of the anode annulus 13 around its 360 degree circumference allows it to be innately aligned in any orientation, thus precluding the need for assembly machines to clock (rotate) the cell 10 relative to the cell frame 44 (FIG. 4) in order to weld.

Referring to FIG. 2, there is shown a cell 10 and a positive, cathode ring 16 in the cathode ring and cell weld assembly, without the other components that would already be in place. The cathode ring 16 would already be pre-welded to the positive collector 52 (FIG. 4), however, in FIG. 2, the collector is not shown for clarity. The cathode ring 16 is welded to the cell 10 by laser welding a relatively substantial conjoined cathode ring foot 46 to the relatively thick cathode button 48 in the cell center on top of the cell. The annulus 17 of the cathode ring 16 is supported above the top of the cell 10 and the cathode ring contacts the cell only at the point of its combined foot 46. From the annulus 17 of the cathode ring 16 three legs 47 are extended downward on an angle, spaced around the ring circumference, into the conjoined single foot 46. The combined single foot 46 is of smaller diameter than the overall cathode ring diameter because as the ring legs extend downward they also extend diagonally inward and meet near the ring center point. The upper annulus 17 is flat, and contact can be made with a positive conductive layer or positive collector 52 anywhere on the entire lower surface of the annulus 17 during prior stages of the assembly. The foot 46 is flat, and contact can be made with the cell button 48 anywhere on the surface of the foot during final stages of the assembly. This is one of the final steps in the cell holder assembly process. The cathode foot weld to the cell button 48 completes the top-down cathode connection weld in one of the final stages of the assembly of the battery pack.

The cathode ring connection to the cell 10 is preferred as the final cell weld after cell population in the frame 44 (FIG. 4) because the cathode buttons 48 are easier to weld with their much larger, flat and thicker target area than the anode crimp 18, thus making intimate contact and over-penetration much less of a concern.

The cathode ring 16 is stamped out (cut) in a horizontally flat disc shape with holes that define the legs and is then formed into shape. It is made of 110 copper, for example, for efficient conductivity.

For a number of reasons, the cathode ring 16 is intentionally designed with cutouts 20. The main advantage of the multitude of air spaces built into the cathode ring, by its perforated ring shape as opposed to a full disc, and how it is supported above and beyond the cell 10 by its three extended legs 47 joined to one common foot 46, is to provide routes for gas egress in the event of a cell failure.

The cathode ring allows for 360 degrees of connections originating from any of the points around the underside of its annulus. However, three welding points around the underside of the annulus 17 of the cathode ring 16 effectively bind the ring to the positive collector 52 with sufficient mechanical strength. Joining the ring to the cell 10 by a single conjoined foot 46 using a single weld also provides sufficient mechanical strength.

Triple redundant welds to the collector stack and a larger, singular common foot weld to the cell 10 below, not only provide confidence in the long term strength of the physical bond, but also provide back-up in case of an undetected weld failure to the annulus 17. Multiple or large connections also create more conducting cross-section, thereby reducing resistance, resulting in heat reduction in the electrical system. For the upper connection, the triple welds act as an additional thermal bridge of the cathode ring 16 to the thermal mass of the positive collector 52 (FIG. 4). This is also a reduction in the electrical resistance, resulting in heat dissipation in the overall system.

The symmetry of the cathode ring 16 shape around its 360 degree circumference allows it to be innately aligned in any orientation, thus precluding the need for assembly machines to clock (rotate) the ring relative to the collector stack (FIG. 4) in order to weld the two together.

Referring to FIG. 3, there is shown a cell 10 with both the anode ring 12 and cathode ring 16 assembled together as they would be when welded to the top of the cell 10. Not shown is the positive collector 52, to which pre-welded connection to the cathode ring is made. This pre-weld connection occurs prior to completing the final cathode ring weld connection to the cell. The anode ring weld connection to the anode collector 56 (not shown here) may also have been completed prior to the final cathode ring weld to the cell.

Noticeable is the height difference between the annulus 17 of the cathode ring 16 and the annulus 13 of the anode ring 12 above the cell, which allows for the collector plates' vertical separation as they are interspersed with insulator layers as shown in FIG. 4. The anode and cathode rings as shown together in the depiction are also distinguished by differing overall diameters of their annuli, which match an additional aspect of horizontal separation shown in FIG. 4, whereby the larger diameter anode ring 12 can be reached vertically downward through an anode weld aperture. The negative anode ring annulus 13, integral with three legs and three feet, and the positive cathode ring annulus 17, integral with three legs and a combined single foot, do not make contact with each other at any of their surfaces as they are of opposite polarity. Although the legs of both the anode and cathode rings appear to line up in FIG. 3, they do not need to be.

Referring to FIG. 4, there is shown a cross-sectional view of an assembled battery 30 with collector stack 88 as seen from the side. The height difference between the cathode rings 16 and the anode rings 12 supported above the cell 10 (with the cathode ring extending above the anode ring) accommodates vertical separation of the positive collector 52 and negative collector 56 respectively. There is, as well, an amount of horizontal separation between the different anode and cathode annuli diameters. Note that the cathode ring foot 46 is of smaller diameter than the inner diameter of the anode ring annulus 13. The layers in the collector stack 88 of positive collector 52 and negative collector 56, with insulating layers 50, 54, and 58 interspersed around and between the collectors, are thus all laid out in different levels.

The uppermost layer is the top insulator layer 50, and the upper annuli of the cathode rings 16 fall into the insulator holes 51, which are generally round laser cut holes in the mica material, for example, of the insulator, one hole for each cathode annulus.

The layer underneath is the positive collector 52. It is to the positive collector 52 that the cathode ring 16 is initially pre-welded before the collector stack 88 is combined with the cell frame 44 and cells 10. The cathode ring 16 contacts the positive collector 52 from above the positive collector. The cathode ring 16 is welded to the positive collector 52 at any point around the ring circumference, usually in three places. The positive collector 52 may be in several pieces or plates.

The inter-conductor insulator 54 is the middle layer, which separates both positive collector 52 and negative collector 56. PET (polyethylene terephthalate) VHB (very high bond) laminates are exemplary materials used for the insulative layers, with laser-cut patterns for each cell or other hole. Each intermediate insulation layer may be a double-sided adhesive layer, for example. Mica may be used, for example, as an outermost layer on top of the current collector assembly after all of the welding operations have been performed.

The next layer down is the negative collector 56, which connects to the anode rings 12 when the collector stack 88 is added to the cell frame 44 populated with cells 10. The anode ring 12 contacts the negative collector 56 from beneath the negative collector. The negative collector 56 may also be in several pieces or plates. The anode welding apertures 136, formed from hole extension 108 and holes 113, 119, appearing in three locations around the cathode rings 16 just beyond the cathode ring circumference, line up vertically over the upper three stack layers to allow vertical access to the negative collector 56. Despite the negative collector 56 being thicker than the annulus 13 of the anode ring 12, it is possible to laser-weld the two together from the thicker side, i.e. from the negative collector, by judicial choice of power ramp and welding duration.

The bottom insulator 58 is the bottom layer of the collector stack 88. It is mounted on a frame top 59 (head gasket), which is mounted on the top of the frame 44. The frame top 59 is partially penetrated by posts or studs on the cell frame 44, or by the upper edges of the frame walls, in order to locate the collector stack 88 in position on the cell frame.

The FIG. 4 perspective is a depiction of a vertically sliced portion of an assembled battery 30 as seen from the side and looking through the levels. Both the anode and cathode rings sit in holes 57, 51 respectively, which are lined up vertically and which have been cut out from their respective stack layers. FIG. 4 shows the five collector stack layers divided horizontally into several differently sized blocks, depicting portions of layers which may be present as a sectional cut or visible in the background. The portions of layers centered in the region above the cathode button 48 are seen in the background. The intermittent and vertically aligned anode welding apertures 136 created in the uppermost three layers, centered approximately every 120 degrees around the cathode annulus circumference, allow vertical access to the anode collector 56 through the stack 88. The collector stack layers are of differing thicknesses in this embodiment, although this is not a requirement.

Note the electrode connector rings 16, 12 make physical and electrical contact with their collector plates 52, 56 respectively around their entire annuli, even though they may be welded in fewer (three for example) discrete locations. The electrode connector rings 12, 16 also make lower connections to the cell 10 via the anode ring pre-weld and the cathode ring foot final weld. The anode ring 12 is pre-welded to the cell crimp 18 at the anode foot 14 via the intermediary anode leg 19 which extends downward on an angle, outward, to the anode foot 14. The anode foot 14 is curved to make a secure connection to the curved cell crimp 18, and the rigidity of the legs 19 and feet 14 provide stability to support the annulus 13 of the ring 12 above and beyond the cell. To help electrically separate the anode ring feet 14 and leg 19 appendages from the cathode button 48 there is a cap insulator 38 shown on the cell upper surface. The anode ring 12 extends three legs 19 with feet 14 attached equally spaced around the ring.

The cathode ring final weld to the cell button 48 is made after the frame 44, cells 10 and collector stack 88 are combined and the other connections are made, as it is a relatively simple and secure weld even with all the other parts and connections in place. The cathode ring 16 is welded to the cell 10 at the large thick cell button 48 area in the final step of the assembly process. The intermediary cathode legs 47 extend downward and inward on an angle toward the cell center where the three legs meet and form one combined cathode foot 46 for the final cathode ring weld. The rigidity of the legs 47 and combined foot 46 provide stability to support the annulus 17 above and beyond the cell 10. The combination of the joining welds as well as the confining cell frame 44 all work to hold the battery pack in place and keep the components secure.

During assembly, when the collector stack 88 is joined to the cell array, the anode ring 12 and cathode ring 16 have a spring compliance effect for contact with the negative collector 56 and cathode button 48 respectively, ensuring reliable, repeatable intimate contact with their interconnections. The negative collector 56 and positive collector 52 of the collector stack 88 are used as tools to compress the anode rings 12 and cathode rings 16, however the rings are not substantially malleable, which is what is desired for the sprung compression of the rings prior to the final joining of the collector stack 88 to the cells 10 in the frame 44.

The collector stack has homogenized targets to make the vision systems more efficient not only for welding assist but for analyzing post weld. Regular welding patterns simplify laser welding programming during the weld cycle. Simplicity and precision eliminate the need for additional, complex and expensive tooling later in the welding process by providing the required accuracy and compliance from the start of the battery pack assembly.

Welding efficiency in the battery results in a decrease in overall system heating compared to prior battery packs. Less system heating allows for a reduction in the size of the interconnecting stack holes, since larger holes would not be as necessary for cooling. With the greater average collector cross-section achieved with minimized hole cutouts, the resistance is lowered, which further results in improved cooling.

Since the burden of achieving precision in the system now exists largely in the collector stack 88, less precise cell frames 44 may be accommodated and joined to it. The permitted degree of misalignment between the cell frame 44 and collector stack 88 may be more than in prior art battery packs, and to a certain extent it may account for different sizes of cells and compensate for dimensional differences in cell heights due to variations in the cell manufacturing process. This is advantageous because of the difficulty in attaining precision manufacturing of modules with the battery frames pre-loaded with cells, as opposed to manufacturing the collector stack 88 as a separate assembly. Without adequate cell-loaded battery frame precision during manufacturing in prior art assemblies, the welding machine later has to compensate for manufacturing variations and individualize surgical corrections. These post-manufacturing steps increase the production cycle time.

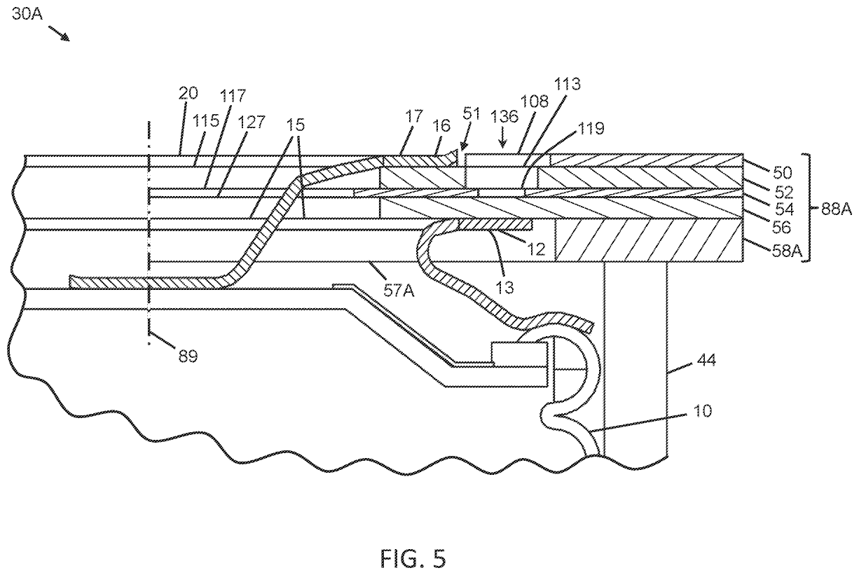

Referring to FIG. 5, there is shown a simplified stylized representation of a sectional view of an assembled battery 30A with collector stack 88A as seen from the side. Vertical line 89 is the centerline of the cell 10. Gas venting occurs directly through the collector stack holes in the region of the anode and cathode rings. From top to bottom, these holes are hole 20 in the cathode ring 16, hole 115 in the positive collector 52, hole 117 in the intermediate insulator later 54, hole 127 in the negative collector 56, hole 15 in the anode ring 12, and hole 57A in bottom insulator layer 58A. The anode ring 12 and cathode ring 16 are shown, as well as the anode and cathode leg and foot appendages. The annulus 17 of the cathode ring 16 sits in hole 51 in upper insulator layer 50. An anode welding aperture 136 is formed of hole extension 108, hole 113 and hole 119, which occur intermittently in three places around the cathode ring circumference to vertically expose the anode collector 56.

There is a height difference between the cathode annulus 17 and the anode annulus 13 supported above the cell 10, with the cathode ring extending above the anode ring. This allows for vertical separation of the positive collector 52 and negative collector 56 respectively, as well as for an amount of horizontal separation with the different anode and cathode ring diameters.

The uppermost layer is the top insulator layer 50. The layer underneath is the positive collector 52. The inter-conductor insulator 54 is the middle layer, which separates both positive collector 52 and negative collector 56. The next layer down is the negative collector 56. The bottom insulator 58A is the bottom layer of the collector stack 88A, mounted directly on the cell frame 44, e.g. via a layer of VHB adhesive integrated with the bottom layer. This view shows a region where the cell frame 44 does not penetrate the bottom insulator 58A.

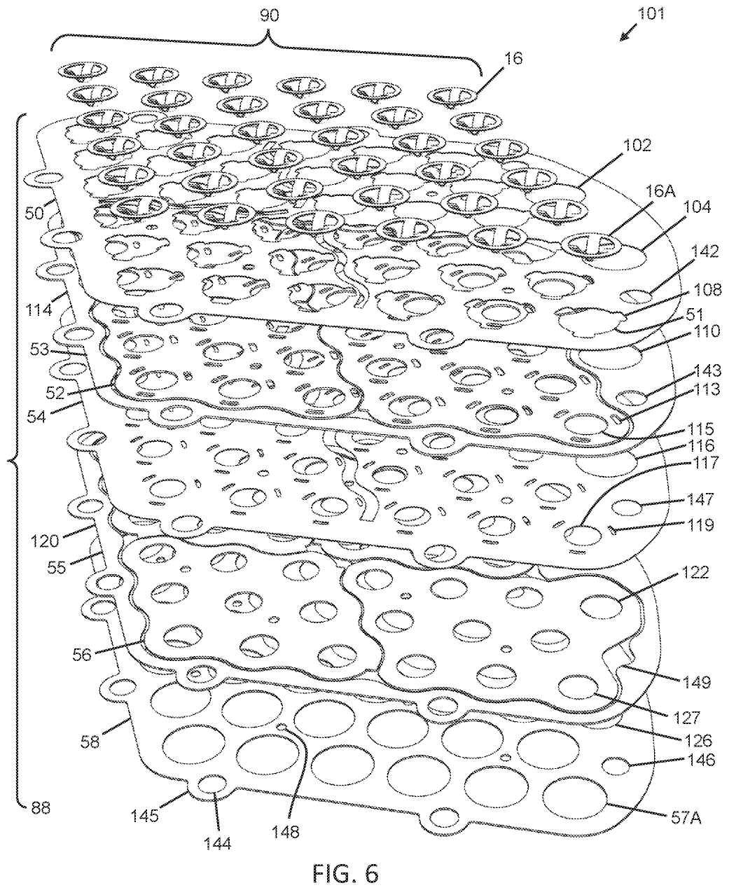

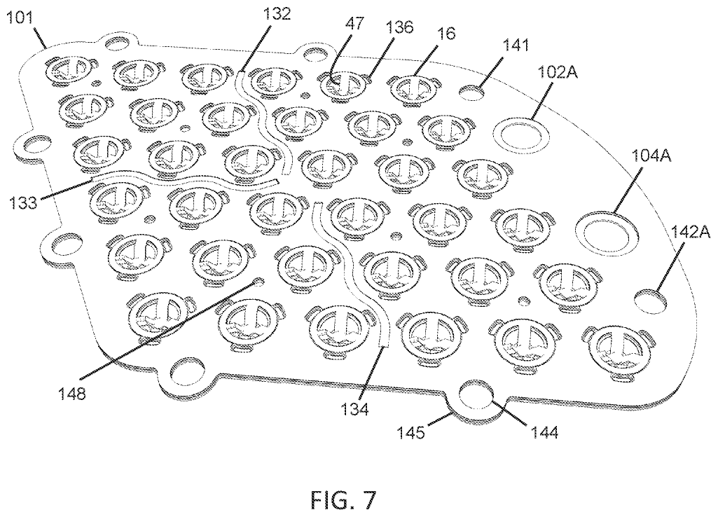

Referring to FIGS. 6 and 7, there is shown an exploded view and an assembled view of a collector assembly 101. The collector assembly is made up of the collector stack 88 and the array 90 of cathode rings 16. Of the electrode connectors, only the cathode rings 16 are present in the collector assembly.

In the battery there is an array of cells arranged symmetrically as six rows by six columns in a hexagonal array, with all the cells lined up in two planar directions. The cathode rings 16 (e.g. ring 16A) line up vertically with holes 51, 115, 117, 127, 57A in the levels of insulator and collector layers (50, 53, 54, 55, 58). Each of the collector layers is divided into multiple plates, which are not directly electrically connected to each other. In addition, there are two opposite polarity cathode and anode access ports 102A, 104A respectively along one side of the thirty-six rings. There are also six external frame fixing holes 144 in protrusions 145 around the edges (two on three sides of roughly a four-sided collector assembly), eight fixture holes 148, three wavy-line weld ports 132, 133, 134 aligned with the collector plate edges, and two additional frame fixing holes 141, 142A running vertically through the layers. The weld ports 132, 133, 134 allow for interconnections between the different plates of the anode layer 55 and the cathode layer 53 in order to create electrical parallel-series connections of the cells.

The dimensions of the collector assembly 101 are such that there is unobstructed vertical access to the foot of each cathode ring 16 and three points on the negative collector 56 above each annulus 13 of an anode ring 12.

The uppermost layer is the top insulator layer 50, and the upper annuli of the cathode ring 16 are located in the insulator cavities through round laser cut holes of the top insulator layer, one hole for every annulus.

The layer underneath is the positive collector layer 53, which has the positive collector 52 and insulating border 114. It is to the positive collector 52 that the cathode ring 16 is initially pre-welded before the collector stack 88 is combined with the cell frame 44 loaded with cells 10 with their anode rings 12. The cathode ring 16 contacts the positive collector 52 by being inserted into holes 51 in the upper insulator layer 50. The cathode ring 16 may be welded to the collector 52 at any point around its annulus, for example in three places. The positive collector 52 is in several pieces or plates.

The inter-conductor insulator 54 is the middle layer, which separates both positive collector 52 and negative collector 56.

Intermittently in three equidistant places around the circumference and beyond the diameter of the cathode ring 16 there is a hole extension 108 and holes 113, 119 in the top three layers of the collector stack 88 to allow vertical access to the negative anode collector plate 56. The resulting three anode welding apertures 136 are staggered with respect to the three cathode legs 47, as seen in FIG. 7, although this is not a requirement.

The next layer down 55 has the negative collector 56, which connects to the anode rings 12 when the collector assembly 101 is added to the populated cell frame 44. The anode ring 12 contacts the negative collector 56 by extending up from beneath the collector 56 and may be welded in any location around its annulus, often being welded in three places. The negative collector plates 56 are also in several pieces, some of their edges vertically accessible through the weld ports 132, 133, 134 in the upper three stack layers. The anode welding apertures 136, appearing in three locations around the cathode rings 16 just beyond the cathode ring circumference, allow vertical access to the anode collector 56.

Note that every layer contains holes of varying diameters which line up vertically either to transmit current or hold the collector stack layers in place with respect to each other and individual cells, with respect to a multitude of cells in a frame, as well as in the battery compartment. The cathode ring 16 protrudes down through the collector stack 88 and through the top insulator layer 50. The cathode access port 102A and an anode access port 104A run vertically through the collector assembly 101 to make positive and negative connections, respectively, outside the battery pack. The anode access port 104A is visible in the exploded view through the layers at hole 104, hole 110, hole 116, hole 122 in the negative collector 56, and hole 126. Cathode access port 102A is made up of hole 102 and other aligned holes below it. Mounting hole 142A runs vertically through the collector assembly 101 to make mechanical connections to the battery pack, with the mounting hole 142A visible in the exploded view through the layers at hole 142, hole 143, hole 147, gap 149 between the insulator 120 and negative collector 56, and hole 146 in the bottom insulator 58.

The combination of the joining welds as well as the confining cell frame 44 all work to hold the battery pack in place and keep the cells secure, as well as the non-conductive holes (141, 142A) in FIG. 7 and their connecting components which align vertically through the five stack layers. Eight stack stud holes 148 spread quasi-evenly over each layer in the collector assembly 101, two positioned on each quarter collector plate section and four on the half plate section as see in FIG. 7, affix the stack to the cell frame 44 via screws, for example, which extend downward through the collector stack and into the frame, with insulating layers throughout the stack. Six external frame fixing holes 144 in protrusions 145 around the edges in each layer of the stack 88 are for securing the assembled battery pack within a battery compartment or monocoque. The two holes 141, 142A at the side of the stack beside the negative access port 104A and positive access port 102A, may be used as frame fixing holes to secure the assembled battery pack within a battery compartment.

While FIG. 7 does not delineate each layer of the collector assembly 101 as in FIG. 6, it does exemplify their aligned vertical access ports 102A, 104A, and thus their resulting exposure to external electrical connectors to a motor, which are also unseen in this drawing. The anode rings 12 are not visible in this rendering as they are not yet connected. The two opposite polarity circular access ports—the positive access port 102A and the negative access port 104A are along one side of the thirty-six rings.

Three weld ports 132, 133, 134 meander around the cathode rings 16 on two axes on the top insulator layer 50 and the inter-conductor insulator layer 54 along the centerlines. These cut through and partially bisect the top two conductor layers along two axes to reveal the edges of the cathode collector 52 and anode collector 56 plate sections, which lie vertically in line with the weld ports 132, 133, 134 and are used for bonding the plate sections. A plate from the positive collector layer is welded to a neighboring negative plate from the negative collector layer through the weld port. This allows groups of 9 cells in parallel to be connected in series.

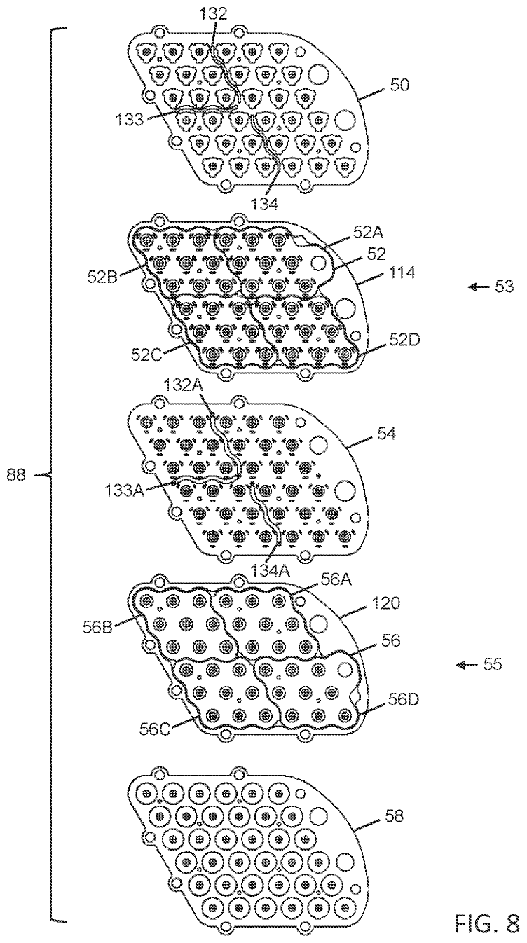

FIG. 8 shows in plan an exploded view of the layers 50, 53, 54, 55, 58 of the collector stack 88. Layer 53 includes the positive collector 52 and the insulation 114 around the positive collector. The positive collector 52 is divided into four plates 52A-D, which are not electrically connected directly to each other. Layer 55 includes the negative collector 56 and the insulation 120 around the negative collector. The negative collector 56 is divided into four plates 56A-D, which are not electrically connected directly to each other.

Starting from the positive terminal of the battery, which is a direct connection to cathode plate 52A, the 9 cells connected to it are also connected to anode plate 56A. The left edge of anode plate 56A is welded to the right edge of cathode plate 52B through a weld port 132, the electrical connection passing through aperture 132A in insulator layer 54. The 9 cells connected to cathode plate 52B are also connected to anode plate 56B. The bottom edge of anode plate 56B is welded to the top edge of cathode plate 52C through a weld port 133, the electrical connection passing through aperture 133A. The 9 cells connected to cathode plate 52C are also connected to anode plate 56C. The right edge of anode plate 56C is welded to the left edge of cathode plate 52D through a weld port 134, the electrical connection passing through aperture 134A. The 9 cells connected to cathode plate 52D are also connected to anode plate 56D, which is a direct connection to the negative terminal of the battery.

### C. Process

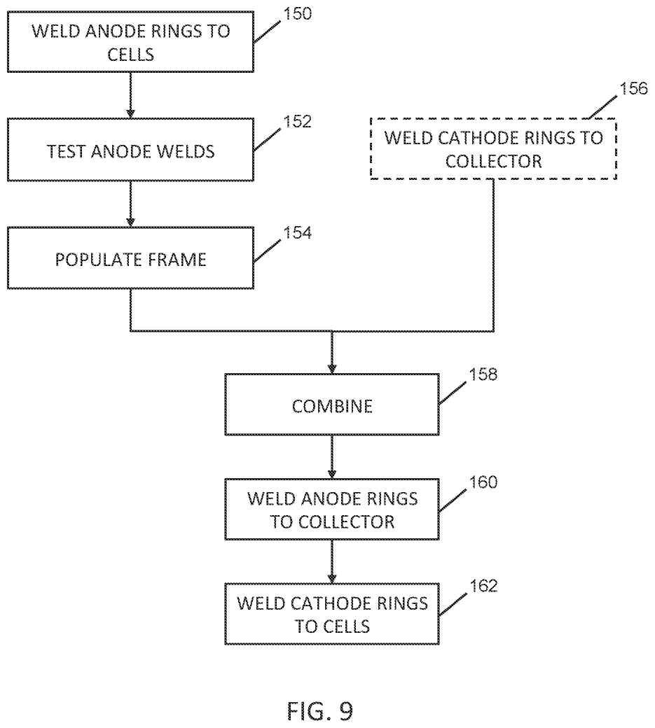

Referring to FIG. 9, there are shown the steps to assemble the battery. The first step 150 in the assembly procedure is the anode ring to cell pre-weld at the challenging cell crimp location. The anode ring 12 (FIG. 1) self locates when placed on the cell. The anode ring 12 is pre-welded to the cell 10 by welding three anode feet 14 at equidistant points around the ring to corresponding points on the cell crimp 18 at the top of the cell. The negative anode ring is pre-welded to the cell surface before any further assembly involving the cell.

The pre-weld of the most difficult weld not only permits a more accurate weld, but additionally allows for individual cells to be tested in step 152, and the rejected specimens discarded, before the entire array of cells is assembled in the cell frame. Rejected cells may be reworked and reused in some situations.

The frame is populated by a multitude of cells all with their anode rings pre-welded in place in step 154. The anode-to-crimp pre-weld offers a preliminary quality control opportunity for improved individually managed welds, expedited assembly, and limited wastage. As a result, the cell population in the frame at this point increases efficiency.

In parallel to the above steps, in step 156 the cathode rings 16 are pre-welded to the positive collector 52, either in a pre-assembled collector stack 88 or, in other embodiments, to individual positive collectors 52. The cathode ring self locates when placed in the pre-assembled collector stack 88. In another embodiment, the cathode rings are integrated into the top layer of the conductors, as a single piece, to remove one of the welding steps completely, i.e. to remove step 156.

The cells in the frame and the collector assembly are combined in step 158, by placing the collector stack and cathode ring assembly over the frame that is loaded with cells and their respective anode rings. The tooling to assemble the current collectors and modules may be ridged to compress all of the rings for welding compliance. The collector assembly (101, FIG. 7) is compressed onto the cells with their conjoined anode rings.

The cell and collector stack combination thus allows the anode rings to be connected to the anode collector in step 160, by welding. The anode ring has a spring compliance effect so that it has reliable, repeatable, intimate contact with the underside of the negative collector for its subsequent connecting weld.

In the final step 162, the cathode rings are connected to the cell buttons by the cathode ring feet, which extend downward to make contact with the cell and thus complete the cathode ring connections to fully bind the collector assembly 101 to the cells 10.

### D. Variations

The anode ring or cathode ring may be half annealed or fully annealed. Annealing tunes the springiness and compliance, as well as the plastic deformation once the current collector stack has been compressed and welded to the cells. The anode ring and/or cathode ring are made with 1100 series aluminum in other embodiments. The collectors or collectors and all rings may be made with aluminum in some embodiments. Insulating materials other than mica may be used. For example, PET layers with adhesive transfer tape, or polyester layers with adhesive transfer tape may be used. Overmolded injection parts with adhesive tape may be used.

The terminal locations on the cell, and the cell architecture and structure may be altered in other embodiments. The ring pairs (anode ring and cathode ring) on each cell may be connected to the polarities opposite to those described above, with the lower outer ring becoming the positive terminal and the upper inner ring switching to have negative polarity, for example. It is recognized that other shapes are possible in other embodiments. For example, other ring shapes and stack holes, cell shapes, or module shapes besides the 6×6 cell array are possible. Battery packs with different numbers of cells are possible in other embodiments.

In other embodiments, the current collectors may be laminated differently to way shown in FIG. 6. For example, the current collector stack may be made of plastic injection overmolded conductors, adhered together.

While the number of legs, feet, and ring welds to the collector have been described as three, a different number of legs, feet, and ring welds may be used. For example, the combined foot of the cathode connector may in some embodiments be three separated feet. In other embodiments, there may be four welds per annulus. While the locations of the legs, feet, and ring welds to the collector have been evenly spaced and staggered around the ring circumference, the locations and grouping of the legs, feet, and ring welds to the collector may be altered.

The electro-chemical cells described herein may be exchanged for other types of electricity-generating cells or materials.

Laser welding may be substituted for other types of physical or chemical connections.

Components that are integral may be made from discrete components fixed together. In some embodiments, the physical proportions of the components may be different to those shown in the embodiments described herein. Separate components may be made as integral components in other embodiments.

Individual holes shown in the components may be combined into larger holes in some embodiments. In other embodiments, holes may be subdivided into smaller holes. Additional holes may be present in the various layers of the stack assembly, for example, in order to increase the venting capability of the battery pack. Some of the holes shown in the embodiments above may be omitted. Some components in some embodiments may be omitted to provide other embodiments of the stack assembly, the cells, and the modules. Holes and other features may be in different positions in other embodiments.

In general, unless otherwise indicated, singular elements may be in the plural and vice versa with no loss of generality. The orientation of components depicted in the drawings may be different in other embodiments.

Depending on the embodiment, one or more, but not necessarily all of the advantages described herein may be provided.

Throughout the description, specific details have been set forth in order to provide a more thorough understanding of the invention. However, the invention may be practiced without these particulars. In other instances, well known elements have not been shown or described in detail and repetitions of steps and features have been omitted to avoid unnecessarily obscuring the invention. Accordingly, the specification and drawings are to be regarded in an illustrative, rather than a restrictive, sense.

It will be clear to one having skill in the art that further variations to the specific details disclosed herein can be made, resulting in other embodiments that are within the scope of the invention disclosed. All parameters, proportions, materials, and configurations described herein are examples only and may be changed depending on the specific embodiment. Accordingly, the scope of the invention is to be construed in accordance with the substance defined by the claims.

1. A set of electrode connectors for a cell comprising:
a first electrode connector comprising:
a first annulus;
multiple first legs extending from the first annulus; and
a first foot extending from each first leg, wherein the first feet fit over a crimp of the cell; and
a second electrode connector comprising:
a second annulus;
multiple second legs extending from the second annulus; and
a second foot at which the second legs terminate, the second foot dimensioned to fit inside the first annulus.

2. The set of electrode connectors of claim 1 wherein there are three equidistant first legs and three equidistant second legs.

3. The set of electrode connectors of claim 1 wherein:
the first annulus has an outer diameter larger than the second annulus and smaller than the cell; and
the second annulus has a larger inner diameter than the second foot.

4. The set of electrode connectors of claim 1 wherein:
the first feet have a radius of curvature less than a radius of curvature of the crimp; and
when the first electrode connector is compressed onto the crimp the feet conform to the crimp.

5. The set of electrode connectors of claim 1 wherein the second foot is planar.

6. The set of electrode connectors of claim 1 made of a springy material.

7. The set of electrode connectors of claim 1 wherein:
the second electrode connector is connected to a collector stack and not the cell; and
the first electrode connector is connected to the crimp and not the collector stack.

8. A battery comprising multiple cells and for each cell:
a first electrode connector comprising:
a first annulus;
a plurality of first legs extending from the first annulus; and
a first foot extending from each first leg, wherein the first feet are connected to a crimp of the cell; and
a second electrode connector comprising:
a second annulus;
a plurality of second legs extending from the second annulus; and
a second foot at which the second legs terminate, the second foot connected to a button terminal of the cell.

9. The battery of claim 8 wherein:
the cells each have an anode and a cathode;
the crimps are the anodes; and
the button terminals are the cathodes.

10. The battery of claim 8 comprising a collector stack to which the first annuli are connected to multiple first collectors at a first level thereof and the second annuli are connected to multiple second collectors at a second level thereof.

11. The battery of claim 10 wherein the collector stack and first and second electrode connectors define venting routes to tops of the cells.

12. The battery of claim 10 wherein the collector stack defines welding ports via which the first collectors are connected to the first annuli.

13. The battery of claim 10 wherein at least one of the first collectors is connected to one of the second collectors.

14. The battery of claim 13 wherein the collector stack defines a collector welding port via which said one first collector is connected to said one second collector.

15. A method for assembling a battery of multiple cells, the method comprising:
connecting a first electrode connector to each cell by connecting multiple first feet of each first electrode connector to a crimp of each cell, each first electrode connector comprising a first annulus and a plurality of first legs extending from the first annulus and terminating in one of the first feet;
connecting, for each cell, a second electrode connector to a collector stack, each second electrode connector comprising a second annulus, a plurality of second legs extending from the second annulus and a second foot at which the second legs terminate;
connecting the collector stack with the connected second electrode connectors to the first annuli; and
connecting each second electrode connector connected to the collector stack to a button terminal of each cell.

16. The method of claim 15 comprising compressing the collector stack with the connected second electrode connectors onto the first annuli while connecting the collector stack with the connected second electrode connectors to the first annuli.

17. The method of claim 15 comprising evaluating the connections of the first electrode connectors to the cells prior to connecting the collector stack with the connected second electrode connectors to the first annuli.

18. The method of claim 15, wherein rotational alignment of the first electrode connectors, the second electrode connectors and the cells is unnecessary.
